(19) United States
(12) Patent Application Publication
(10) Pub. No.: US 2006/0032936 A1
(43) Pub. Date: Feb. 16, 2006

(54) Recirculating water fountain

(76) Inventors: Nathan Proch, Los Angeles, CA (US); Robert Grzesek, Redondo Beach, CA (US)

Correspondence Address: ARTHUR FREILICH, 9045 CORBIN AVE, #260, NORTHRIDGE, CA, 91324-3343, US

(21) Appl. No.: 11/254,277

(22) Filed: Oct. 19, 2005

Related U.S. Application Data
(63) Continuation-in-part of application No. 10/609,166, filed on Jun. 27, 2003.

(51) Int. Cl. E03B 9/20; B05B 17/08; A01G 27/00

(52) U.S. Cl. 239/16; 239/17; 239/67; 239/69

(57) ABSTRACT

A recirculating water fountain configured for table/desk top use comprises a water reservoir, a plenum mounted above the reservoir and configured to accumulate a substantially still pool of water, and a pump operable to pump water upwardly from the reservoir to form the water pool in the plenum. The recirculating water fountain includes a visually open flow pathway sloping downward from beneath the plenum to receive water from a plenum overflow for return to the reservoir, and a controller for alternately defining a pump-on mode and a pump-off mode. The pump controller functions to define the pump-off mode in response to the water level in the reservoir falling below a first height mark and to prevent resumption of the pump-on mode until the water level in the reservoir exceeds a second height mark. The open flow pathway includes a first portion defining convex and concave surfaces which guide the sheet flow along a visually pleasing generally sinuous path, and a second downwardly sloping diverging ramp portion which is ridged to produce a visually pleasing rippling effect.

### RELATED APPLICATIONS

This application is a continuation-in-part of U.S. application Ser. No. 10/609,166 filed on Jun. 27, 2003, which, by reference, is incorporated herein.

### FIELD OF THE INVENTION

This invention relates generally to a recirculating water apparatus configured for table/desk top use in a home or office setting to provide pleasing and soothing visual and audible effects.

### BACKGROUND OF THE INVENTION

As the pace of life continues to quicken, objects designed to draw one's attention to aesthetic pleasures and to nature become increasingly important to a person's well-being. A recirculating water fountain configured for table/desk top use in a home or office setting may help draw one's attention to just such an object in an aesthetically pleasing manner and thus serve to reduce a user's stress level.

### SUMMARY OF THE INVENTION

The present invention is directed to an apparatus configured for table/desk top use for recirculating a liquid, e.g., water, to produce a visual and audible display which is soothing and relaxing to a user.

A preferred apparatus in accordance with the invention utilizes a liquid reservoir, e.g., a tub, for containing a volume of water. An electric pump is mounted in the tub for pumping water up a substantially vertically oriented pipe to a plenum. The plenum is configured and dimensioned to pond the water, i.e., to form an essentially still water pool. The plenum is constructed to overflow onto a visually open water flow pathway which then returns the water flow to the tub.

In accordance with a significant aspect of the invention, a pump control, or automatic shut off, subsystem is provided to prevent the pump from running dry. A shut off subsystem in accordance with the invention functions to sense the water level in the tub when the pump is running, (i.e., pump-on mode). If the “running” water level falls below a first height mark (typically attributable to evaporation), a controller shuts off the pump. When the pump shuts off (i.e., pump-off mode), water within the system, e.g., pipe, plenum, ramp, etc., drains back into the tub and raises the “non-running” water level above the first height mark. In accordance with a significant aspect of the invention, the controller prevents resumption of pump operation until the water level rises, e.g., by the user adding water, above a second height mark greater than the first height mark.

More particularly, a system in accordance with the invention includes a detector means for detecting the water level in the tub and a controller means responsive to the detected level falling below a first height, or low, mark for switching the pump off and responsive to the detected level rising above a second, or high, mark for switching the pump back on. A detector means in accordance with the invention can be implemented in a variety of ways. Thus, it can comprise a float carrying a switch actuator, e.g., a magnet, capable of operating first and second switches respectively mounted proximate to said first and second height marks. Alternatively, the level of the magnet can be detected by a magnetic field sensor such as a Hall effect device. In a further alternative detector implementation the float can carry an optical gradient member mounted to reciprocally move between a light source and a light sensor. The float level determines the position of the gradient member and thus the amount of light transmitted from the light source to the light sensor.

Thus, the light sensor output will indicate the relative water level. In an analogous fashion, the float can operate a rheostat whose electrical output will then indicate the float position, i.e., the water head. Further, a suitable detector means can be used in which the water level can be directly measured without necessitating use of a float. For example, spaced electrically conductive strips can be mounted on the tub wall so that the water level in the tub determines the electrical capacitance, and/or conductance, between the strips. The capacitance, and/or conductance, can be measured by suitable electronics (e.g., A/D converter and digital processor) connected to the strips to indicate whether the water level is below the low mark or above the high mark. A further implementation for directly detecting, i.e., without using a float, the water level in the tub can use an energy radiator, e.g., ultrasonic, to transmit an energy pulse from a fixed location which will then be reflected back from the water-air interface. The elapsed time will be proportional to the water level. These implementations, as well as other alternative and equivalent implementations, can be used for detecting the tub water level to determine whether it is below a low mark or above a high mark.

Regardless of the particular implementation, in operation, when the water level drops below the first, or low, height mark, the pump is turned off. Only after water is added to the tub to raise the water level to above the second, or high, height mark, is the pump operation able to resume.

The aforementioned flow pathway is preferably configured to allow the water overflow from the plenum to form an essentially thin sheet as it flows by way of gravity along the pathway toward the tub. The pathway preferably includes a first portion defining convex and concave surfaces which guide the sheet flow along a visually pleasing generally sinuous path. The pathway preferably also includes a second portion comprising a ramp surface which is preferably ridged to produce a rippling effect so as to produce desirable visual and audible water effects.

A preferred apparatus in accordance with the invention includes a housing having wall portions extending peripherally around the tub and flow pathway. The wall portions extend above the tub and preferably converge upwardly to form a slender and attractive table/desk top accessory. The interior housing wall portions are preferably sealed to the tub to prevent leakage therebetween. The housing exterior is preferably configured to display one or more decorative panels.

In accordance with a further aspect of a preferred embodiment, the sealed tub and housing include at least one peripheral window enabling the liquid level in the tub to be viewed from outside the housing.

In accordance with a still further aspect of a preferred embodiment, one or more illumination sources, e.g., LEDs, may be mounted in the tub, preferably below the water level, to produce a variety of pleasing and colorful lighting effects. The flow pathway preferably includes at least one light transmissive portion enabling the lighting effects to be seen from outside the housing.

These and other aspects of the present invention will become apparent from a review of the accompanying drawings and the following detailed description of the preferred embodiments of the present invention.

### BRIEF DESCRIPTION OF THE DRAWINGS

The invention is generally shown by way of example in the accompanying drawings in which:

FIG. 1 is a perspective view of a preferred recirculating liquid fountain in accordance with the present invention;

FIG. 2 is a front view of the recirculating liquid fountain of FIG. 1;

FIG. 3 is a left side view of the recirculating liquid fountain of FIG. 1;

FIG. 4 is a right side view of the recirculating liquid fountain of FIG. 1;

FIG. 5 is a rear view of the recirculating liquid fountain of FIG. 1;

FIG. 6a is a bottom view of the recirculating liquid fountain of FIG. 1;

FIG. 6b is a top view of the recirculating liquid fountain of FIG. 1;

FIG. 7 is a side perspective view of a housing for the recirculating liquid fountain of FIG. 1;

FIG. 8 is a perspective view of a back cover of the recirculating liquid fountain of FIG. 1 adapted for coupling with the housing of FIG. 7;

FIG. 9 is a perspective view of a liquid reservoir (tub) of the recirculating liquid fountain of FIG. 1 adapted for mounting within the housing of FIG. 7;

FIG. 10 is a top perspective view of a tub seal for use with the liquid reservoir (tub) of the recirculating liquid fountain of FIG. 1;

FIG. 11a is a top perspective view of a bottom cover of the recirculating liquid fountain of FIG. 1;

FIG. 11b is a perspective view of a drain cap for use with the bottom cover of FIG. 11a;

FIG. 12 is a perspective view of a front ramp portion of the recirculating liquid fountain of FIG. 1;

FIG. 13 is a perspective view of a ramp window adapted for coupling with the front ramp portion of the recirculating liquid fountain of FIG. 1;

FIG. 14 is a cross-sectional view taken substantially along the plane 14-14 of FIG. 1;

FIG. 15 is a cross-sectional view taken substantially along the plane 15-15 of FIG. 14;

FIG. 16 is a cross-sectional view taken substantially along the plane 16-16 of FIG. 14;

FIG. 17 is a cross-sectional view taken substantially along the plane 17-17 of FIG. 16;

FIG. 18 is a cross-sectional view taken substantially along the plane 18-18 of FIG. 16;

FIG. 19a is a front perspective view of a face plate for use with the recirculating liquid fountain of FIG. 1;

FIG. 19b is a front perspective view of a plurality of decorative members for mounting onto the face plate of FIG. 19a;

FIG. 19c is a top perspective view of a bracket spring for use in mounting the decorative members of FIG. 20b onto the face plate of FIG. 19a;

FIG. 19d is a top perspective view of a bracket for use in mounting one of the decorative members of FIG. 19b onto the face plate of FIG. 19a; and

FIG. 20 is a block diagram of a microprocessor based electronic module for use in the fountain of FIG. 1;

FIG. 21 is a flow chart depicting a pump shut off routine;

FIG. 22 is a diagram depicting a flicker lighting effect;

FIG. 23 is a diagram depicting exemplary LED on/off modulation to achieve a desired lighting effect;

FIG. 24 is a flow chart depicting a flicker routine;

FIG. 25A is a schematic diagram of an alternative detector means using capacitive sensing to determine water level;

FIG. 25B is a schematic diagram of a further alternative detector means using a floating optical gradient member for determining water level;

FIG. 25C is a schematic diagram of a still further alternative detector means using a floating magnet and magnetic field sensor for determining water level; and

FIG. 25D is a schematic diagram of a still further alternative detector means using an energy radiator for determining water level.

### DETAILED DESCRIPTION

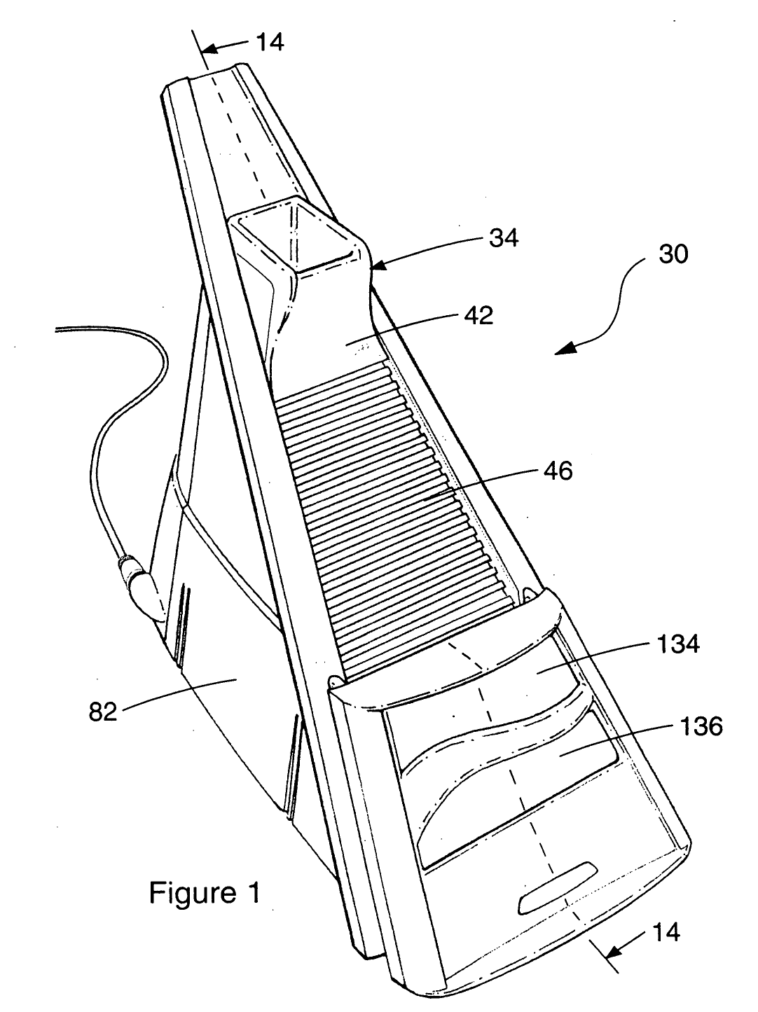

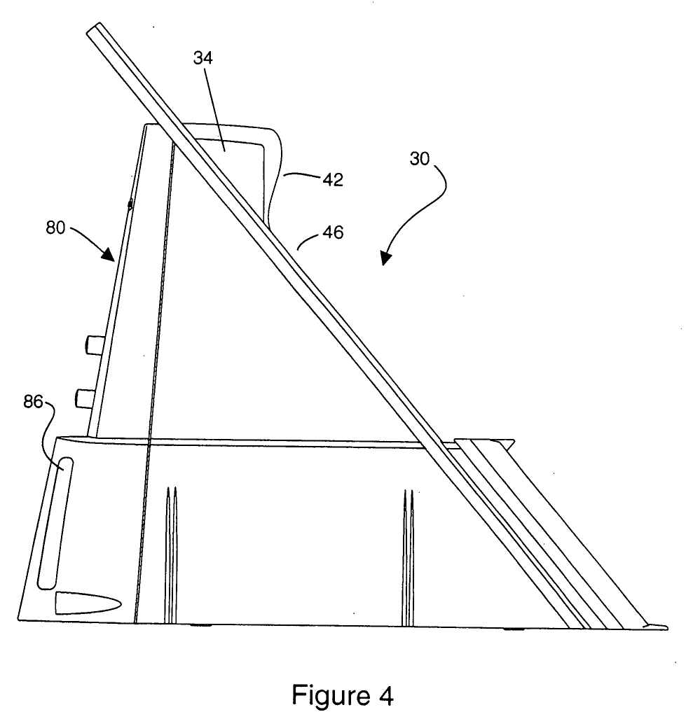

Attention is initially directed to FIGS. 1-6 which illustrate a preferred recirculating liquid apparatus (fountain) 30 in accordance with the present invention. The apparatus 30 is configured for table/desk top use, typically in a home or office setting, for producing a visual and audible liquid flow display which is pleasing and relaxing to the user.

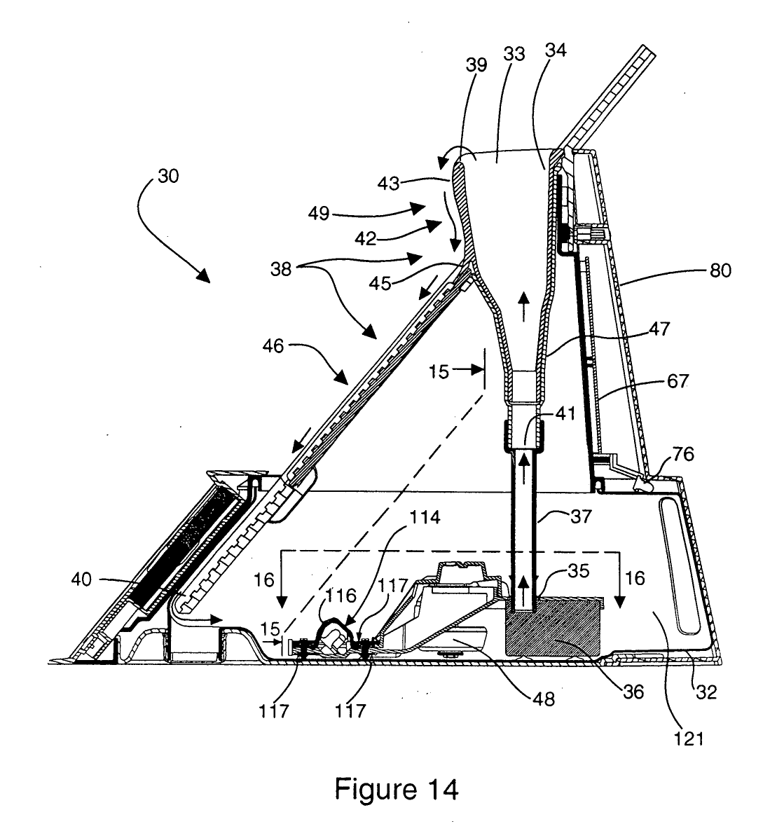

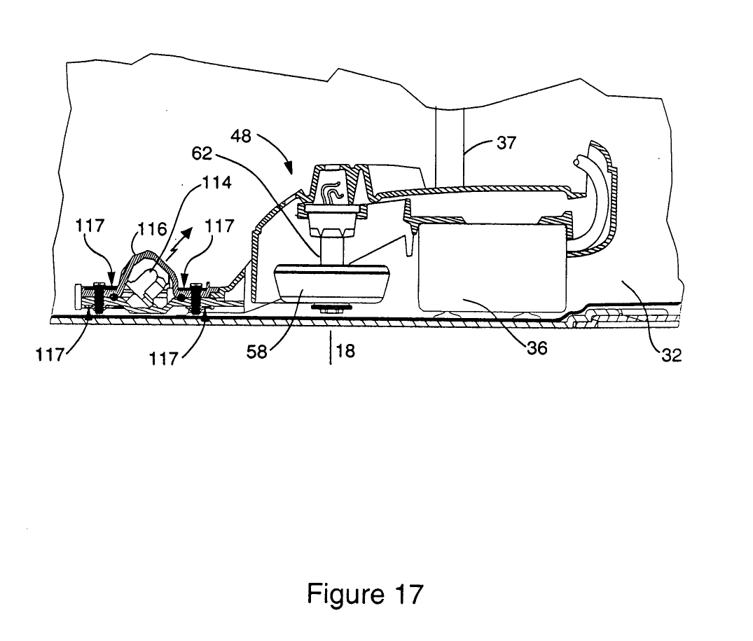

The preferred fountain apparatus 30 generally comprises a reservoir (tub) 32 (FIGS. 9, 14) for accommodating a volume of liquid such as water, a removable plenum 34 (FIGS. 1-4, 14) mounted generally above reservoir 32 and adapted to accumulate a substantially still liquid (water) pool 33 (FIG. 14), and a high efficiency submersible water pump 36 (FIGS. 14, 17) mounted within reservoir 32. The water pump 36 is preferably selected to operate at an almost zero sound level. Plenum 34 is of a generally truncated inverted pyramidal shape to allow the gradual increase in water volume as the water is pumped upward from tub 32 so as to reduce turbulence and form a substantially still water pool 33 (FIG. 14) in the plenum 34. Plenum 34 preferably includes a face portion 49 defined by generally smooth surface having convex and concave portions 43, 45, respectively, as generally depicted in FIG. 14. Water pump 36 is selectively operable in a “pump-on” mode to pump water upwardly from reservoir (tub) 32 via a pipe 37 (FIG. 14) to form the water pool 33 in plenum 34. Specifically, pipe 37 is coupled between an outlet port 35 of submersible pump 36 and an inlet port 41 of a center bracket 47 configured to support plenum 34, as generally shown in FIG. 14.

The recirculating water fountain 30 preferably includes a visually open flow pathway 38 which includes a first curved flow portion 42 generally defined by the convex and concave plenum surfaces 43, 45, respectively, and a second ramp portion 46 sloping downward from beneath plenum 34, as illustrated in FIGS. 1-4, 14. The ramp portion 46 is defined in part by a generally polygonal ramp window 106 made preferably of a light transmissive material(s). Ramp window 106 may be removably mounted onto frame 108 of a generally elongate ramp support structure 110 as shown in FIGS. 12-13. Ramp support structure 110 (FIG. 12) preferably mounts onto a front portion 83 of a housing 82 (FIG. 7) of fountain 30 (FIG. 1) and includes a generally polygonal bottom ramp portion 112 (FIG. 12) which further defines the second ramp flow portion 46, as generally illustrated in FIG. 14.

Plenum 34 is adapted to overflow onto an upstream end 39 of the flow pathway 38 which returns the water flow by gravity to reservoir 32 at a downstream end 40 of bottom ramp portion 112 (FIG. 12) as generally depicted in FIG. 14. Pathway 38 is preferably configured to allow the water overflow from plenum 34 to form an essentially thin sheet as it flows downward toward reservoir 32. Specifically, the plenum surfaces 43, 45 exhibit convex and concave curvatures sufficiently shallow to guide a thin sheet flow along a visually pleasing and substantially smooth sinuous path. The ramp flow portion 46 is adapted to guide the thin sheet water flow along a generally diverging ridged path so as to produce visually pleasing and soothing rippling/cascading effects, as depicted in FIG. 14. Alternatively, first curved flow portion 42 may be provided with a plurality of ridges and/or the ramp flow portion 46 may be made smooth to produce a slightly different water display. Other flow path variations may be utilized, provided such other variations do not depart from the intended purpose of the present invention.

Housing 82 comprises a generally polyhedral base portion 88 (FIG. 7) adapted to enclose snugly tub 32. Tub 32 edges are preferably sealed to an inside surface 89 (FIG. 7) of base portion 88 (of housing 82) using a tub seal gasket 90 (FIG. 10) which conforms to the outer top contour of tub 32, as generally shown in FIGS. 9-10. Once tub 32 is sealed to inside surface 89 of housing 82, recirculating water fountain 30 may be rocked, shaken or safely transported from one location to another without leaking water therebetween. Housing 82 comprises a slender generally pyramidal body portion 87 (FIG. 7) which creates a highly attractive aesthetic appearance as it rises from the foot print it occupies on a table/desk top (FIG. 1).

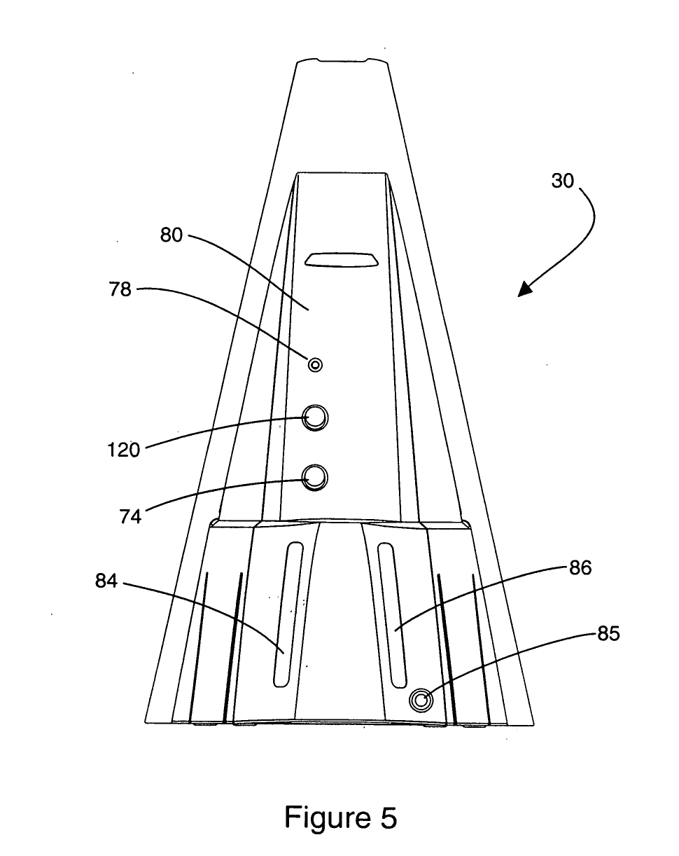

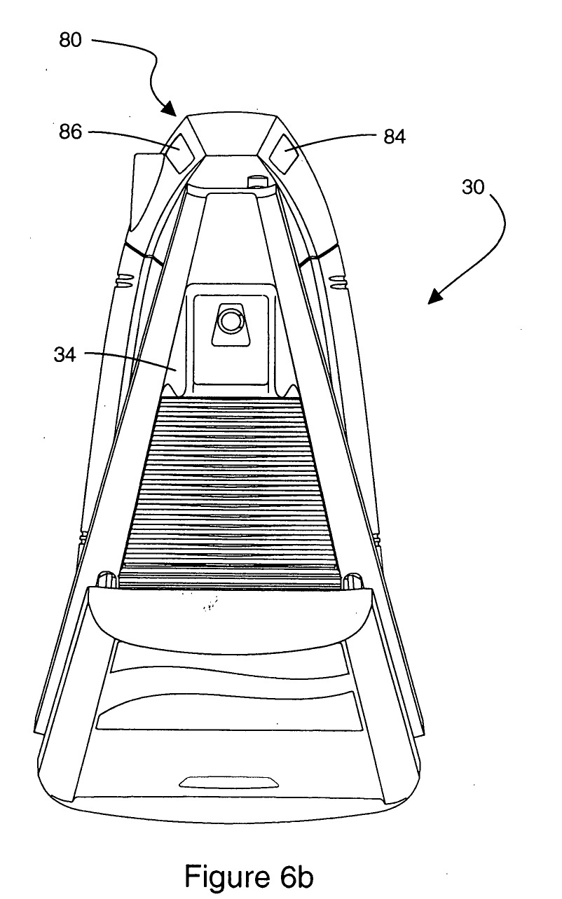

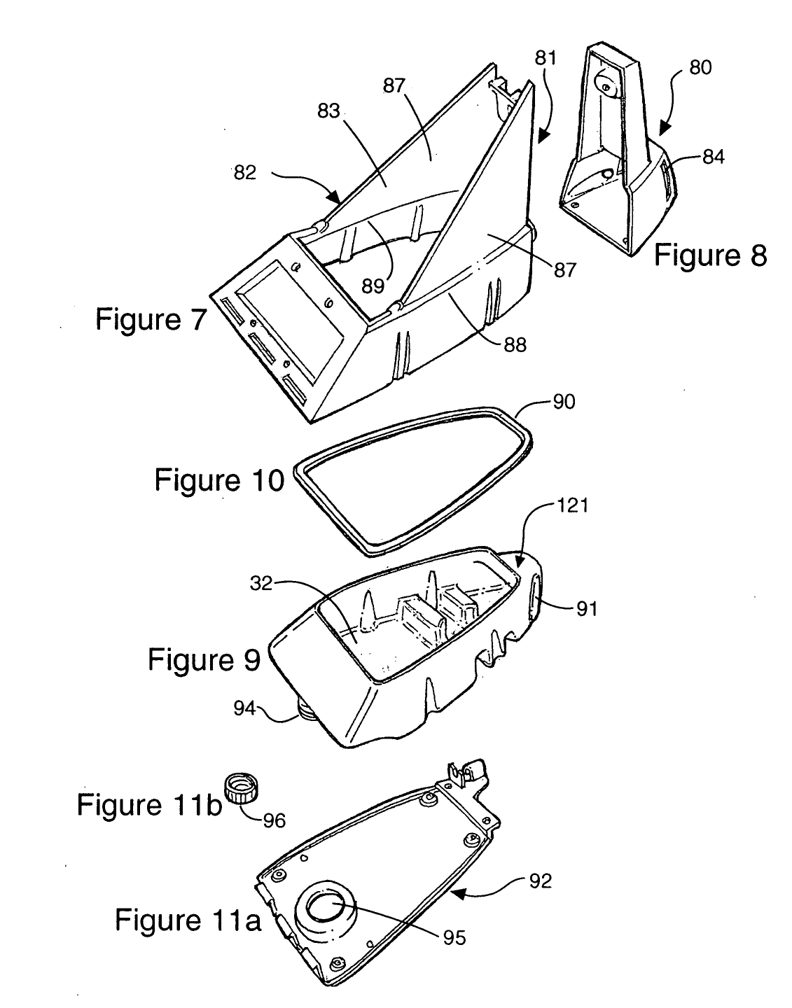

Tub 32 is preferably blow-molded from a suitable plastic material with the tub and housing design allowing for the incorporation of one or more windows for enabling a user to observe the internal water level. For example, a tub water level aperture 91 (FIG. 9) is designed to match the opening provided by a water level indicator window 84 on back fountain cover 80 (FIGS. 5, 8), respectively. As generally shown in FIG. 5, back fountain cover 80 also includes another oppositely disposed water level indicator window 86. The provision of a water level window allows the user to quickly and easily gauge the level of water inside tub 32 during re-filling and/or use of the fountain.

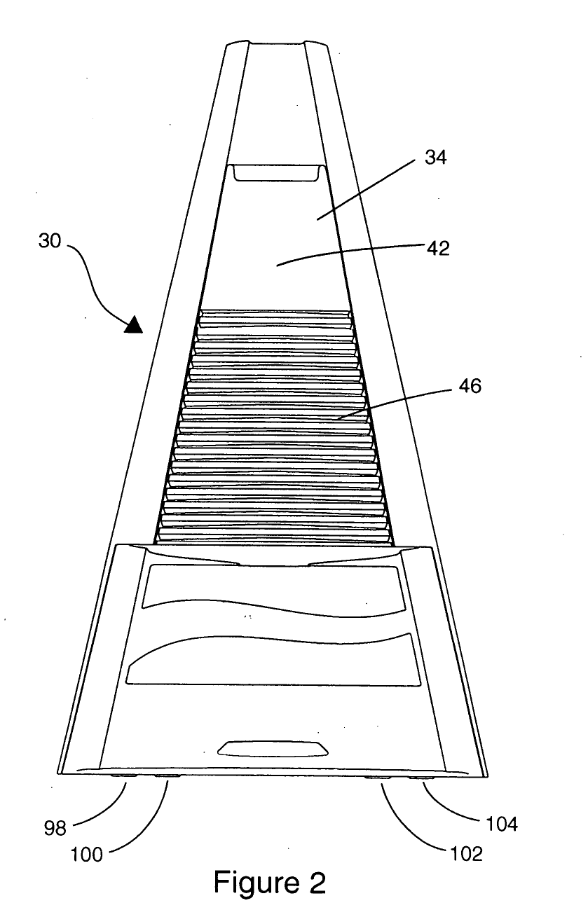

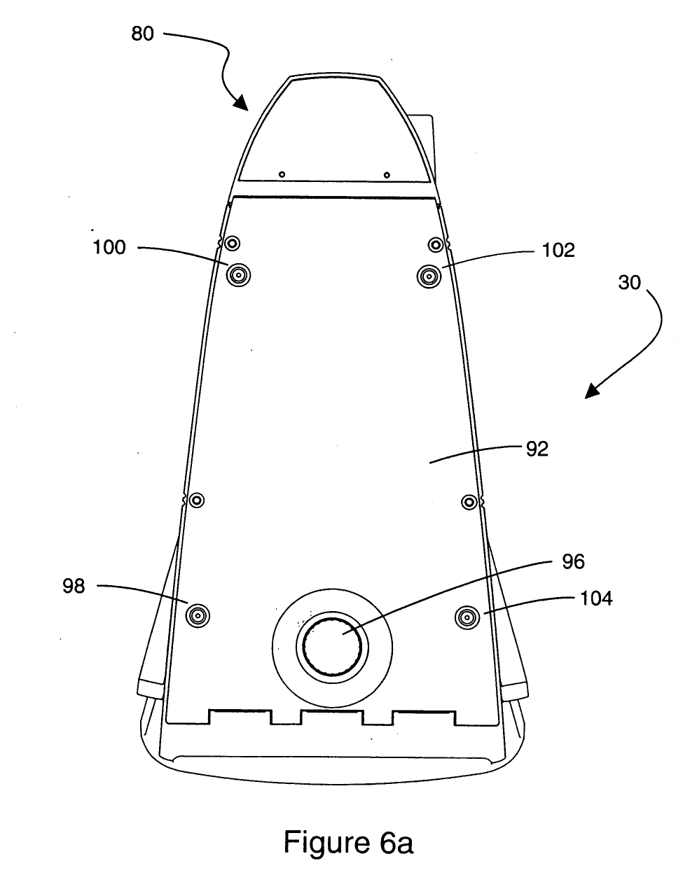

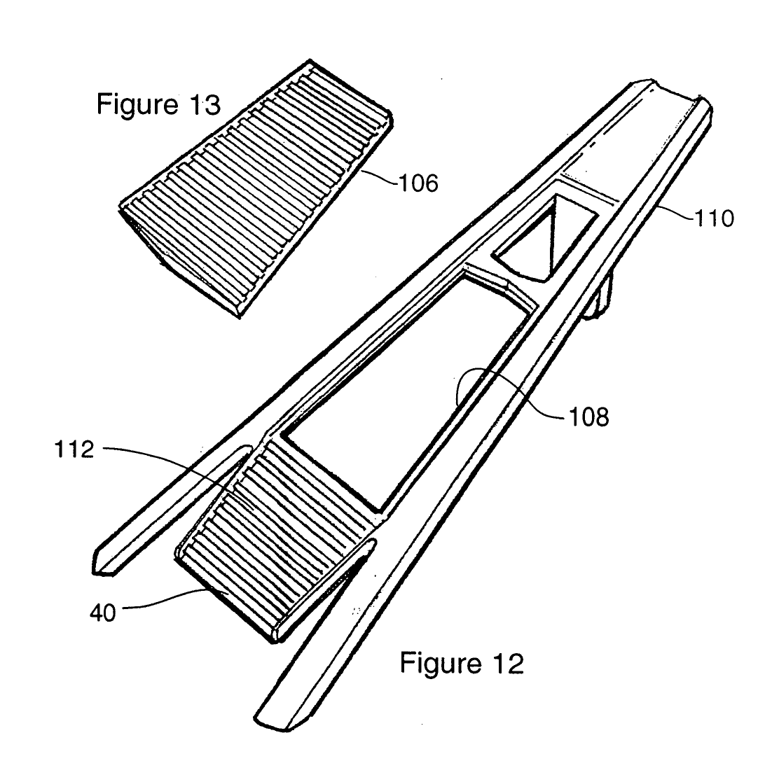

Recirculating water fountain 30 also comprises a removable bottom cover 92 (FIGS. 6a, 11a) which may be mounted to the underside of base portion 88 (of housing 82) after tub 32 has been installed. Tub 32 is preferably provided with a generally circular drain opening 94 (FIG. 9). Drain opening 94 protrudes through bottom cover 92 through opening 95 shown in FIG. 11a. Drain opening 94 enables the tub to be emptied and cleaned relatively easily for the user. During use, drain opening 94 is closed by drain cap 96 (FIG. 11b). The underside of bottom cover 92 may be provided with a plurality of integral foot supports 98, 100, 102, 104 (FIG. 2) made of synthetic rubber or similar material(s) to prevent damage to a desk/table top surface while the fountain is in use.

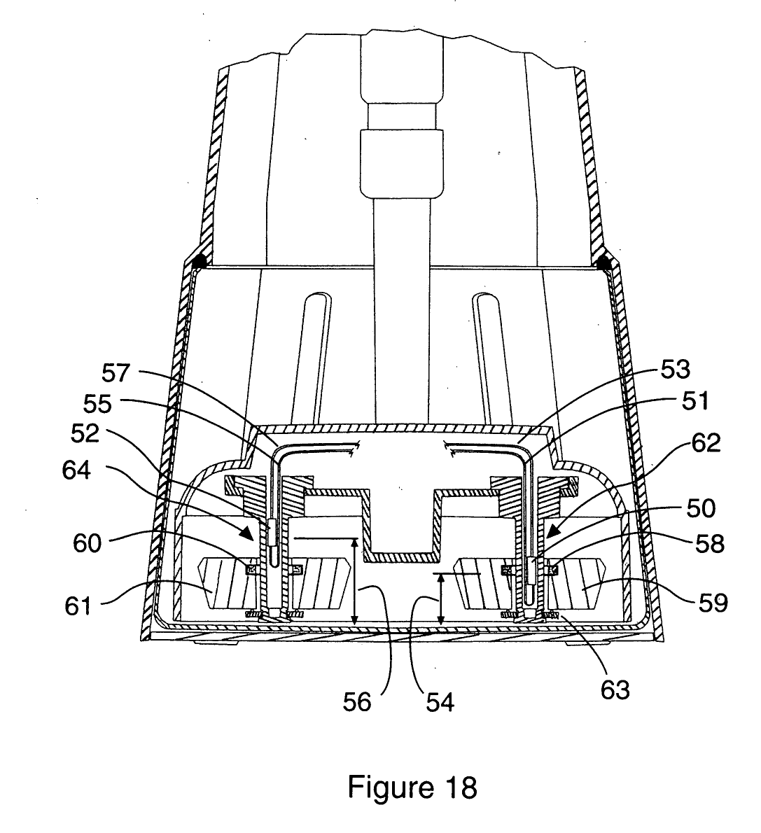

The water fountain 30 further comprises a pump controller 48 (FIG. 14) operatively coupled to pump 36 and configured to prevent pump 36 from running dry. That is, the controller 48 is configured to automatically monitor the “running” water level in tub 32 and to shut off the pump (i.e., “pump-off” mode) when the water level falls below a first height mark and to prevent resumption of pump operation until the water level exceeds a second height mark, higher than the first height mark. In accordance with one preferred embodiment (FIG. 18) of the invention, this automatic shut off functionality is achieved by respectively mounting first and second detector switches proximate to the first and second height marks. Each switch responds to a switch actuator configured to float proximate to the water level in tub 32. For example, the switch actuator can comprise a magnet(s) and the respective detector switches can comprise reed switches configured to close when a magnet is proximate thereto.

FIG. 18 illustrates one preferred pump controller 48 comprising a first reed switch 50 operatively coupled to pump 36 (via electrical connectors 51, 53) and mounted proximate to a first tub height mark 54. A first magnetic actuator 58 is carried by float 59 and positioned to close first reed switch 50 when the water level drops to the first tub height mark 54. More particularly, the float 59 is preferably toroidally shaped and adapted to move vertically on a tubular guide shaft 62 such that it bottoms against stop 63 and closes reed switch 50 when the water level falls to mark 54. The reed switch 50 is preferably encased in resin or similar material(s) for waterproof assembly within the guide shaft 62.

Pump controller 48 also includes a second reed switch 52 operatively coupled to pump 36 (via electrical connectors 55, 57) and mounted proximate to a second tub height mark 56. A second magnetic actuator 60 is mounted on float 61 to close reed switch 52 when the water level in tub 32 rises to the second tub height mark 56. The float 61 is generally ring-shaped and is adapted to move vertically on tubular guide shaft 64 which preferably houses the second reed switch 52. The reed switch 52 is preferably encased in resin or similar material(s) for waterproof assembly.

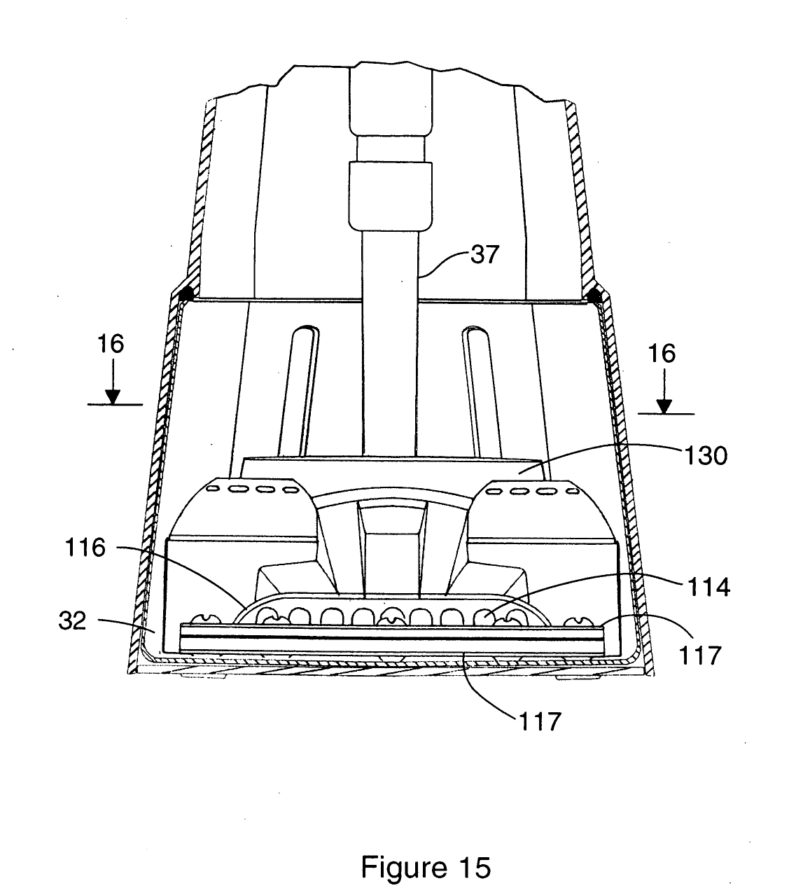

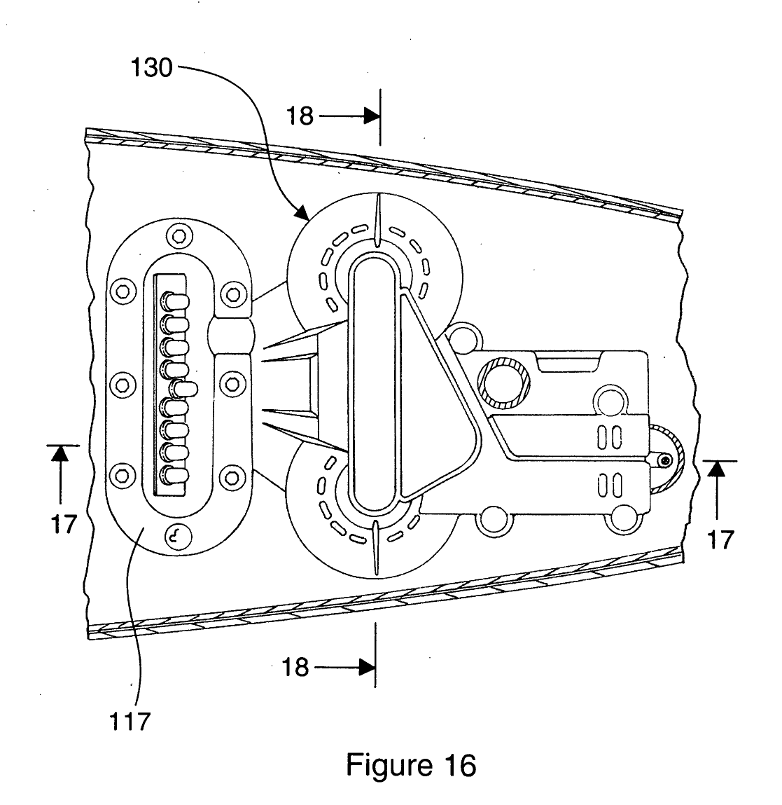

The pump 36, reed switches 50, 52, and respective magnetic actuators 58, 60, are preferably mounted beneath a removable appropriately shaped pump cover 130, as generally shown in FIGS. 15-16.

The locations of the first and second tub height marks 54, 56, are selected to allow for the incremental rise in water level which would occur every time pump 36 is shut off. Specifically, every time pump 36 shuts off, all the water above the pump in pipe 37, in plenum 34, as well as on the ramp flow portion 46 flows back to tub 32 by gravity causing an incremental rise in tub water level. Thus, the height difference between the first and second height marks 54, 56 (FIG. 18) should be greater than the measured incremental rise in tub water level due to pump 36 shutting off. When the tub water level has, due to evaporation, diminished below height mark 54 and fails to rise to height mark 56 even with the incremental rise in water level after shut off, pump 36 will safely remain in the pump-off mode until the user manually replenishes the water supply in tub 32. Water may be easily replenished by the user by removing ramp window 106 from ramp support structure 110 and pouring water into tub 32.

In typical use, pump 36 may operate for about two weeks, depending on the humidity of the operating environment, before shutting off as a consequence of evaporation. In general, the amount of time between required refills is a function of tub size, amount of water being used in the tub, efficiency of the pump, humidity of the operating environment, as well as how water recirculation is managed within the fountain, i.e. how much water is being lost to evaporation due to heat produced by internal lighting sources. Conventional recirculating water fountain designs typically utilize internal halogen light sources which have been found to cause a significant rise in water temperature during operation of the fountain thereby substantially increasing the speed of water evaporation. To resolve this problem, and in accordance with the present invention, fountain 30 preferably utilizes an internal low voltage LED lighting sub-assembly 114 (FIG. 14) characterized by much lower level of heat generation when compared to conventional halogen lighting sources. Another advantage of using low voltage LED lighting sources is a much longer LED life expectancy (at least 10 years), while conventional halogen lighting sources typically burn out in less than 4 months.

More particularly, LED lighting sub-assembly 114 preferably comprises a series of five blue LEDs, two red LEDs, and two turquoise LEDs being hermetically sealed under pressure via a generally ring-shaped metal frame 117 (FIG. 16) in a waterproof light transmissive housing 116, as generally illustrated in FIGS. 14-17. Metal frame 117 is preferably mounted to the bottom surface of tub 32 substantially behind light transmissive ramp window 106, as generally shown in FIGS. 14-17, so as to illuminate open flow pathway 38 in a combination of colors during operation of fountain 30.

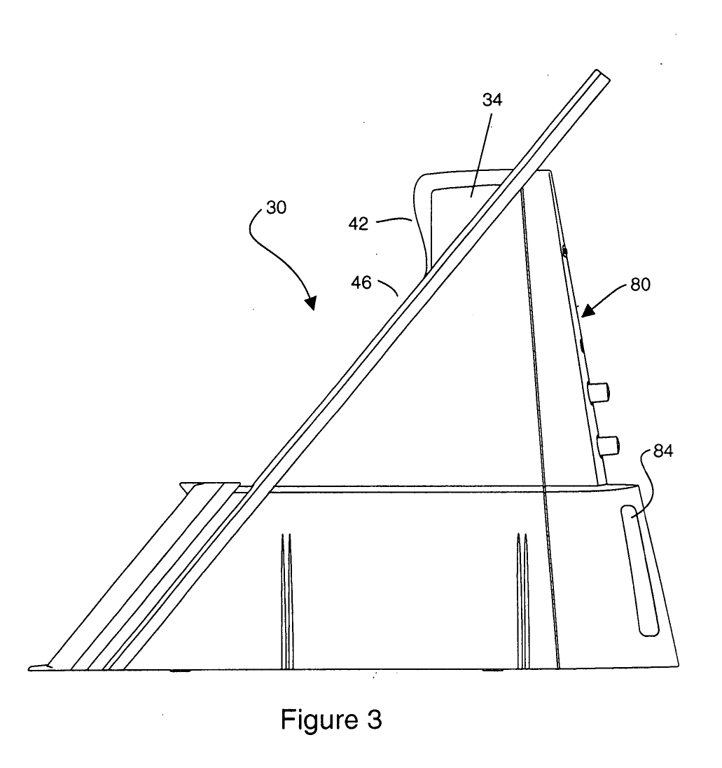

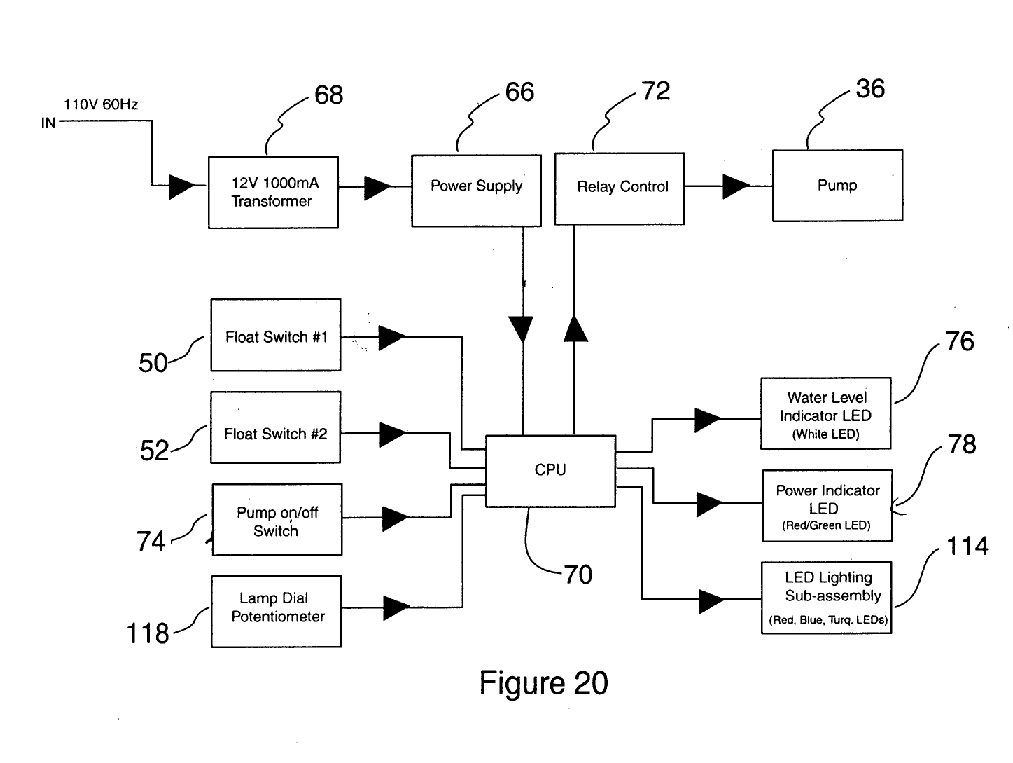

Each LED of lighting sub-assembly 114 preferably comprises an ultra bright LED with a relatively wide range of illumination. The nine LEDs of lighting sub-assembly 114 are adapted to produce fifteen separate color combinations. The color combinations are controlled by a lamp dial 118 (FIG. 20) which is mechanically coupled to a LED dial switch 120 (FIG. 5). LED dial switch 120 is adapted to cycle through fifteen different color combinations and is operatively coupled to back fountain cover 80 (FIG. 8). Back fountain cover 80 is adapted for mounting to a respective back portion 81 (FIG. 7) of housing 82, as generally depicted in FIGS. 3-5.

In use, turning LED dial switch 120 (FIG. 5) all the way in a counter-clockwise direction would result in LED lighting subassembly 114 being turned off. Turning LED dial switch 120 in a clockwise direction cycles lighting subassembly 114 through fifteen different positions (color combinations). What follows is a typical color combination layout:

Position 1=1 Blue LED being “on”. (Light Blue), (Center Blue LED);

Position 2=4 Blue LEDs being “on”. (Medium Blue), (2 Left Blue LEDs and 2 Right Blue LEDs);

Position 3=5 Blue LEDs being “on”. (All 5 Blue LEDs);

Position 4=5 Blue LEDs being “on”, 2 Turquoise LEDs being “on”;

Position 5=4 Blue LEDs being “on”, 2 Turquoise LEDs being “on”. (2 Left Blue LEDs, 2 Right Blue LEDs, 2 Turquoise LEDs);

Position 6=1 Blue LED being “on”, 2 Turquoise LEDs being “on”. (Center Blue LED and 2 Turquoise LEDs);

Position 7=2 Turquoise LEDs being “on”;

Position 8=2 Turquoise LEDs being “on”, 2 Red LEDs being “on”;

Position 9=2 Turquoise LEDs being “on”, 2 Red LEDs being “on”, 1 Blue LED being “on”. (White LED) (Center Blue LED);

Position 10=2 Turquoise LEDs being “on”, 2 Red LEDs being “on”, 4 Blue LEDs being “on”. (2 Left Blue LEDs, 2 Right Blue LEDs);

Position 11=2 Turquoise LEDs being “on”, 2 Red LEDs being “on”, 5 Blue LEDs being “on”.

Position 12=2 Red LEDs being “on”, 5 Blue LEDs being “on”.

Position 13=2 Red LEDs being “on”, 4 Blue LEDs being “on”. (2 Red LEDs, 2 Left Blue LEDs, 2 Right Blue LEDs);

Position 14=2 Red LEDs being “on”, 1 Blue LED being “on”. (2 Red LEDs, Center Blue LED); and

Position 15=2 Red LEDs being “on”.

It should be noted that as new colors are created in LED technology, new colors can be added/upgraded to fountain 30.

A preferred water fountain 30 may be energized by an internal power supply 66 (FIG. 20) which is electrically connected to a 110V, 60 Hz power source via an external 12V, 1000 mA transformer 68. Power supply 66 provides power to a controller, or central processing unit (CPU) 70, which controls the operation of pump 36, i.e. turns pump 36 on/off via a relay control 72 in response to input signals from the first and second switches 50, 52, respectively, and from a manual pump on/off switch 74. Pump on/off switch 74 may be a standard two-position dial knob switch operatively coupled to back cover 80 of fountain 30, as generally shown in FIG. 5. For example, turning pump switch 74 in a counter-clockwise/clockwise direction will open/close the circuit, respectively. Closing the circuit will enable pump 36 and LED lighting subassembly 114 to operate as long as the water tub level is at second tub height mark 56 (FIG. 18) or higher.

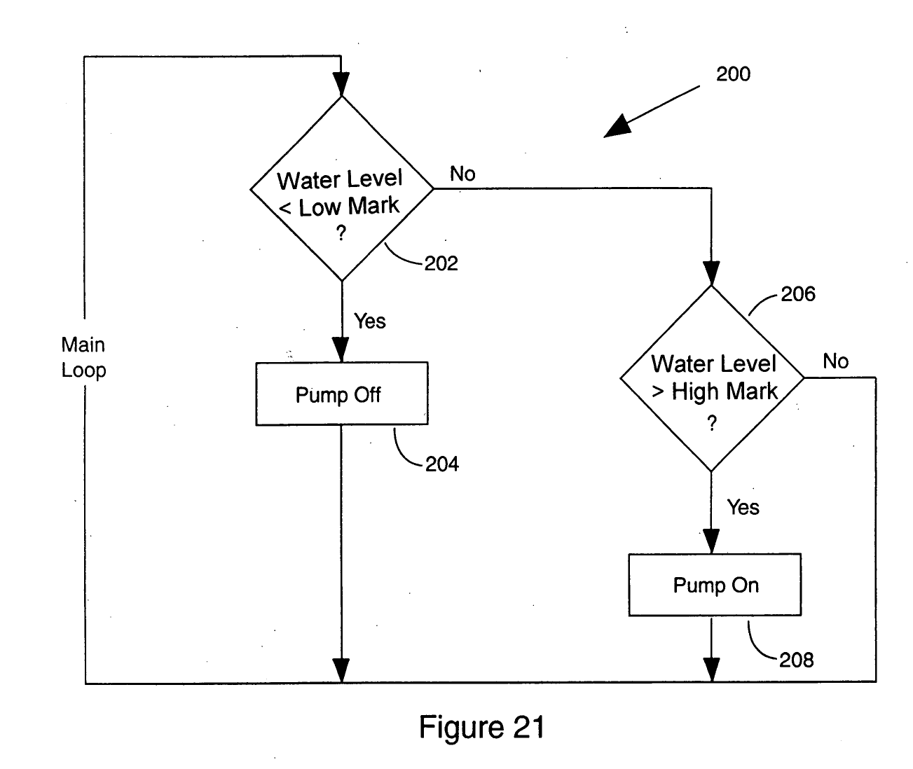

The CPU 70 controls multiple functions including lighting control and pump shut-off operation. FIG. 21 comprises a flow chart depicting execution of a routine 200 for performing the previously described automatic pump shut-off function in conjunction with the pump controller 48 comprised of actuators 58, 60 and switches 50, 52 (FIG. 18). The routine 200 is periodically executed by the CPU 70, e.g., as part of the CPU's main loop.

Routine 200 is comprised of decision block 202 which asks whether the water level is below the low height mark 54, e.g., is switch 50 (FIG. 18) closed? If yes, operation proceeds to block 204 to shut off the pump and then returns to the CPU's main loop. If the water level is above mark 54, i.e., switch 50 is not closed, then operation proceeds to decision block 206 which asks whether the water level is above the high height mark 56, e.g., is switch 52 closed? If no, then operation returns to the main CPU loop. On the other hand, if sufficient water is in the tub to float magnet actuator 60 to mark 56 and thus close switch 52, operation will proceed from block 206 to block 208 to turn the pump on. Operation then returns to the main CPU loop.

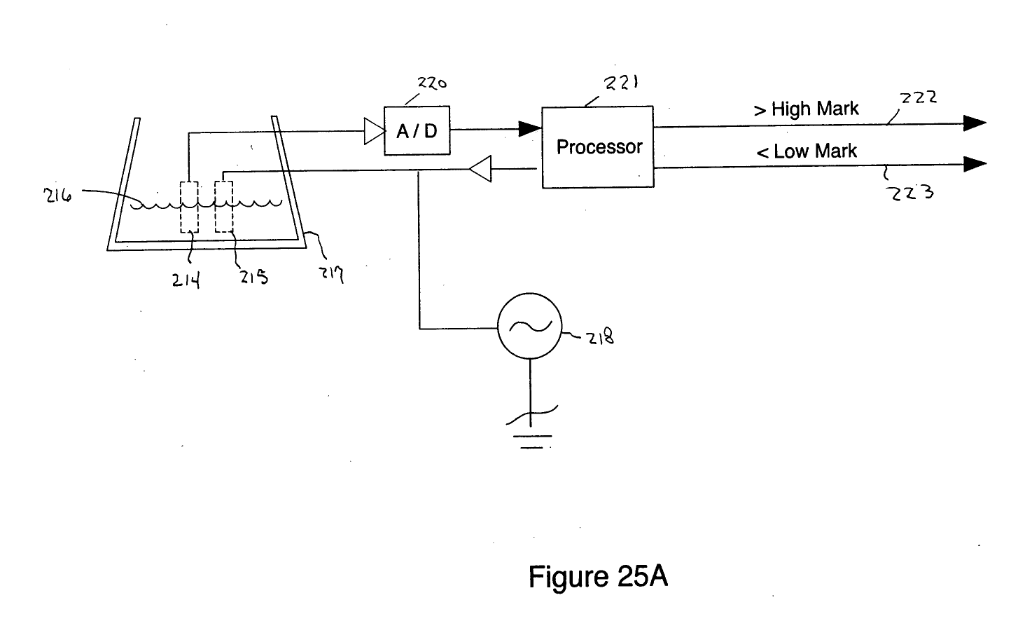

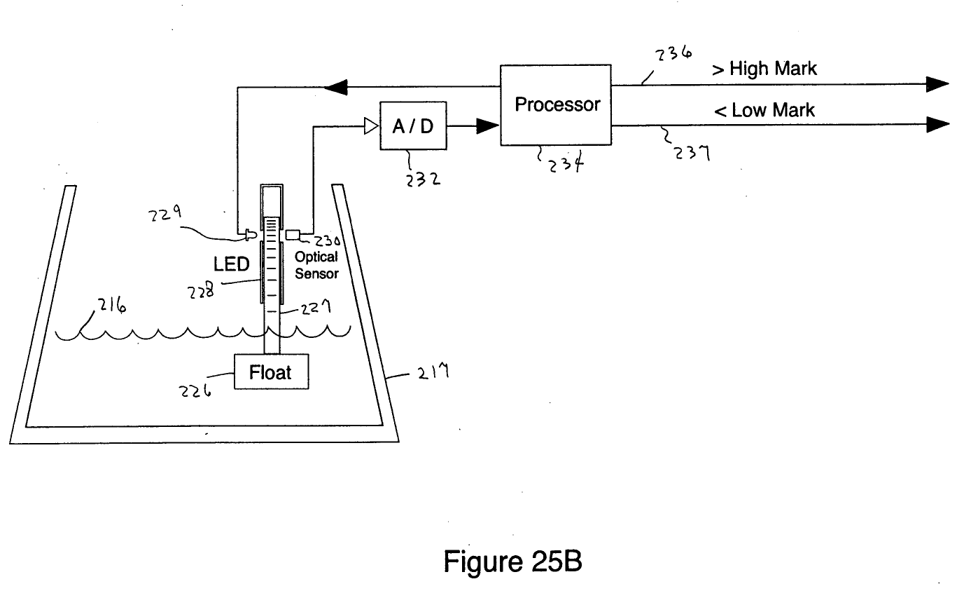

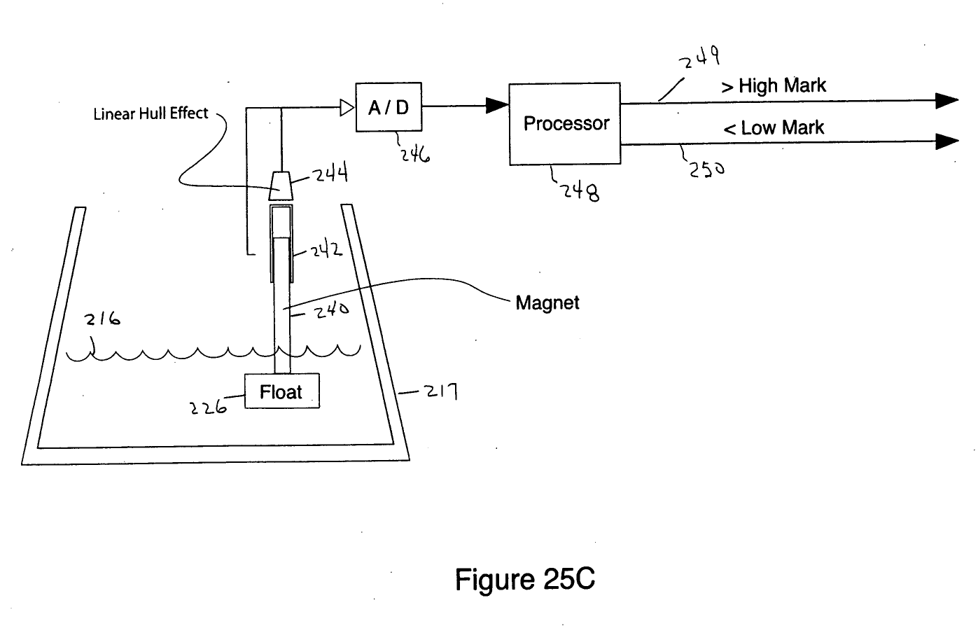

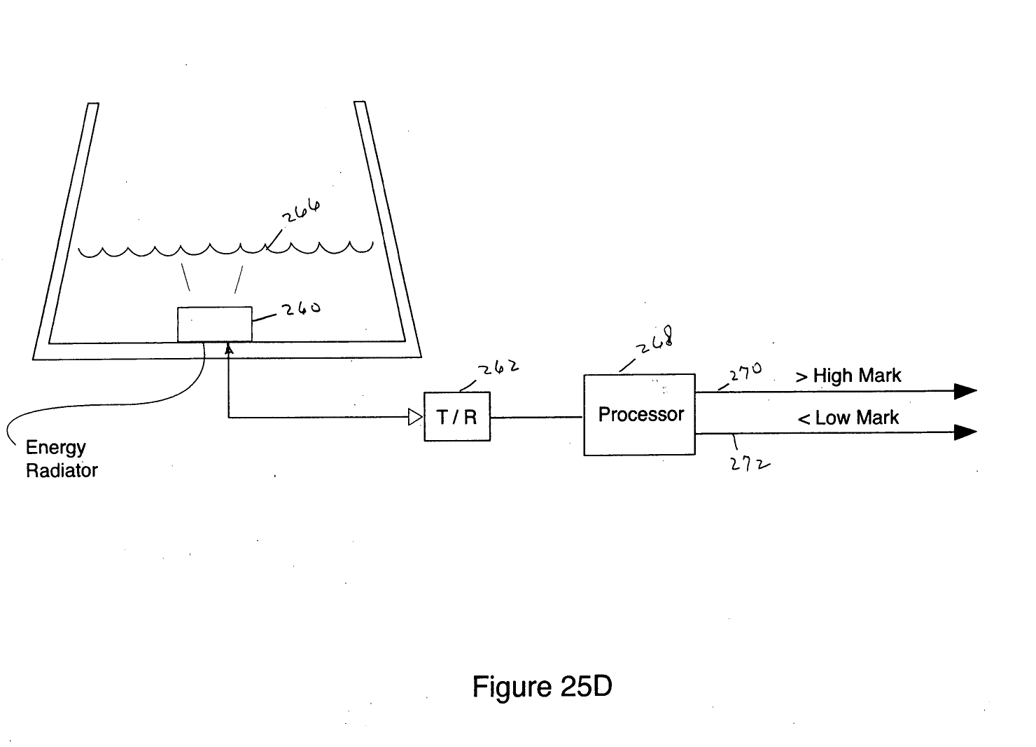

The routine 200 of FIG. 21, as thus far described, has primarily assumed the pump controller implementation of FIG. 18 in which first and second floating actuators 58, 60 respectively operate switches 50, 52 to detect and report on the water level in order to control pump operation. It is pointed out, however, that many alternative implementations, consistent with FIG. 21, can be employed for detecting the water level and controlling the pump operation. For example, attention is directed to FIG. 25A which illustrates an implementation in which first and second electrically conductive strips 214, 215 are mounted on the wall of tub 216. The electrical capacitance between the strips 214, 215 varies as a function of the water level 216 in tub 217 and can be measured by appropriate electronic circuitry connected to the strips. FIG. 25A schematically depicts one arrangement of electronic circuitry in which an AC source 218 supplies a signal to strip 215. The capacitance coupling between strips 215 and 214 produces a signal on strip 214 whose characteristics are a function of the electrical capacitance between the strips. The signal from strip 214 is connected, via an A/D converter 220, to a digital processor 221 which them provides an output 222 if the water level is above a high mark or an output 223 If the water level is below a low mark.

Attention is now directed to FIG. 25B which illustrates a further alternative implementation for detecting whether the water level 216 in tub 217 is above a high mark or below a low mark. The implementation of FIG. 25B uses a float 226 which carries an optical gradient member 227. The member 227 is configured so that its light transmissivity varies along its length. The member 227 is mounted to move along a linear path within guide sleeve 228, as the water level changes. The linear path extends between a light source 229, e.g., LED, and an optical sensor 230, e.g., phototransistor. The output of sensor 230 is connected, via A/D converter 232, to digital processor 234. In use, when the water level 216 is low, the float 226 moves member 227 to a downward position to move a low transmissivity region between light source 229 and sensor 230. On the other hand, when the water level 216 is high, the member 227 presents a high transmissivity region between the source 229 and sensor 230. By monitoring the output from sensor 230, to processor is able to provide an output 236 if the water level is above a high mark or an output 237 if the water is below a low mark.

FIG. 25C depicts an implementation similar to FIG. 25B but instead of using an optical gradient member 227, the float 226 carries a magnet 240 mounted for linear movement in guide sleeve 242. A magnetic field sensor 244, e.g., linear Hall effect device, is mounted adjacent to the magnet 240. When the water level 216 is low, the magnet 240 is remote form the sensor 244 which thus provides a low level output, via A/D converter 246, to processor 248. When the water level is high, the magnet moves closer to the sensor to increase its output. The processor can thus readily distinguish between a water above a high mark (output 249) and a water level below a low mark (output 250).

In another alternative arrangement (not shown) similar to FIGS. 25B and 25C, the float can move a mechanical member to vary a rheostat to modify an electric signal and thus indicate whether this water level is above a high mark or below a low mark.

FIG. 25D illustrates a still further alternative implementation for detecting tub water level and producing an output indicating whether the water level is above a high mark or below a low mark. The implementation uses an energy radiator 260, e.g., ultrasonic, and transmit/receive (T/R) electronics 262. The T/R electronics periodically activates the energy radiator to generate a pulse which is transmitted through the water pool 264 and is then reflected back from the water-air interface 266. The reflected pulse is received by the radiator 260 and returned to the T/R electronics 262. By measuring the elapsed time between the pulse launch and return, the processor 268 can determine the height of the water-air interface, i.e., water level, to produce outputs 270 and 272.

CPU 70 also preferably controls one or more of the LED light sources in subassembly 114 to produce, interesting and pleasing lighting effects through the translucent/transparent ramp window 106. One particularly significant lighting mode in accordance with the invention functions to produce a flame-like flicker behind the ramp window.

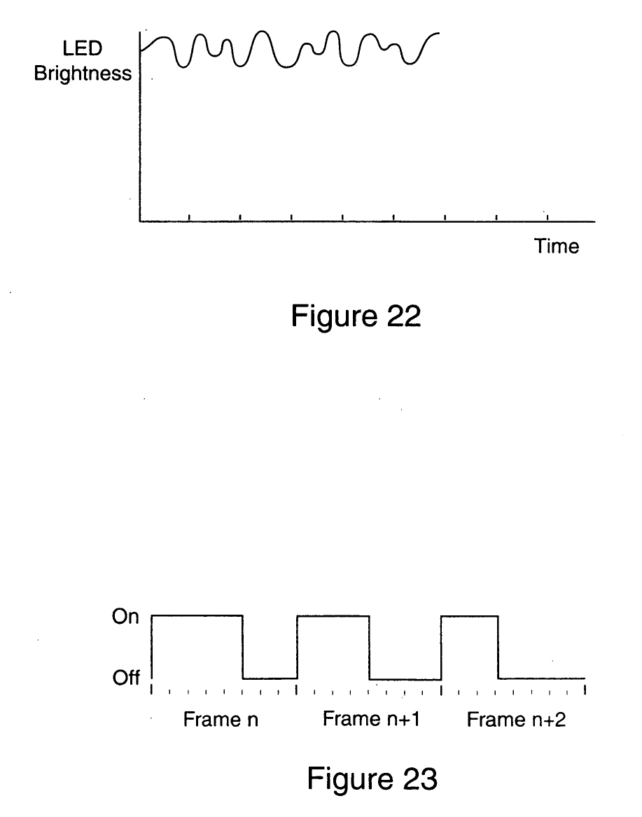

FIG. 22 shows an exemplary plot of LED brightness vs. time to represent the desired flicker effect for one or more LED's. In accordance with a preferred embodiment of the invention, the LED brightness can be varied as represented in FIG. 22 by varying the LED on/off time during successive time slots. For example, assume that the time axis in FIG. 22 is comprised of successive contiguous frame intervals of uniform duration (e.g., 1/62.5 sec.). Then assume that each frame interval is comprised of x successive contiguous time slots (e.g., 128 slots/frame). In accordance with the invention, in order to achieve the desired flicker effect, and LED is held on for a certain number (0-x) of time slots during each frame. FIG. 23 depicts an exemplary LED operation during three successive frames n, n+1, n+2 in which the on duration of the LED gradually diminishes.

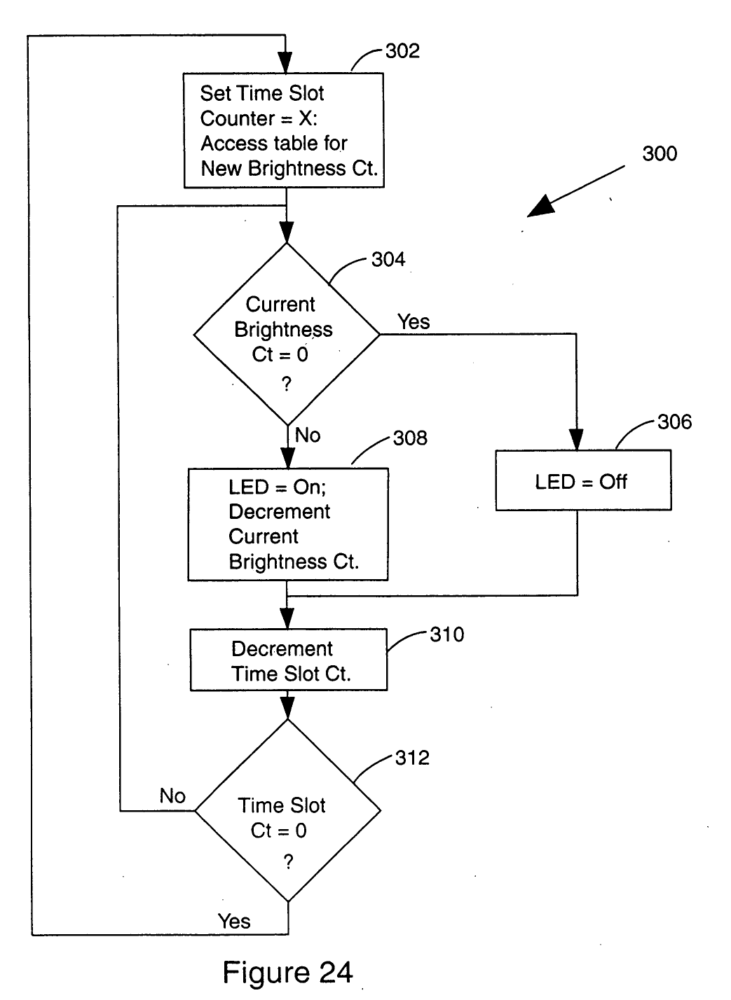

FIG. 24 comprises a flow chart depicting an exemplary flicker routine 300 executed by the CPU 70 for controlling the LED brightness to achieve the flicker effect represented in FIG. 22. Briefly, for each successive frame, the CPU 70 accesses a new brightness count (block 302) from a stored data table which brightness count represents the desired LED on duration during the frame. Then, the LED is kept on while the current brightness count is successively decremented until the LED is turned off when the count reaches zero.

More particularly, at the beginning of each frame, block 302 is executed which initializes a prime slot counter and accesses a table to retrieve a new brightness count for the current frame. Operation then proceeds to decision block 304 which asks whether the current brightness count is equal to zero.

If yes, then operation proceeds to block 306 which turns off the LED. If the answer to decision block 304 is no. then operation proceeds to block 308 which maintains the LED on and decrements the current brightness count.

After execution of either block 306 or 308, the time slot count is decremented in block 310. Operation then proceeds to decision block 312 which asks whether the time slot count is equal to zero. If no, then operation loops back to decision block 304. If yes, meaning that the full complement of frame time slots have been completed, operation loops back to block 302.

From the foregoing explanation of FIG. 24, it should now be understood that during each time frame, the LED will be held on for a certain number of time slots (i.e., 0-x) dependent upon the value of the new brightness count accessed from the table for that frame. In an exemplary embodiment of the invention, each frame has a duration of 1/62.5 seconds and is comprised of 128 time slots. This rate is sufficiently fast that the eye does not perceive that the LED is actually turning on and off but rather perceives a variation in brightness, as represented in FIG. 22 which simulates a fire-like flicker effect.

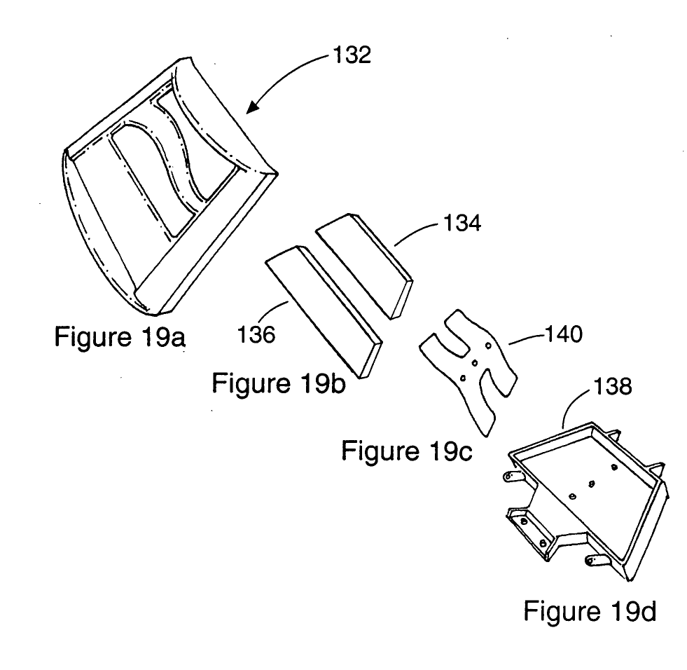

CPU 70 preferably also controls additional functions including the operation of a water level indicator LED 76 (FIGS. 14, 20) and a power indicator LED 78 (FIGS. 5, 20) in response to input signals from the first and second reed switches 50, 52, pump on/off switch 74, and power supply 66, respectively. Water level indicator LED 76 is disposed within back cover 80 and adapted to generally illuminate a rear portion 121 (FIGS. 9, 14) of tub 32, and more specifically to illuminate from inside tub 32 water level indicator windows 84, 86 (FIG. 5) so as to allow the user to easily gauge the level of water in tub 32 from outside. Water level indicator LED 76 is electrically coupled to reed switches 50, 52 and is preferably lit when pump dial on/off switch 74 (FIG. 5) is in an “on” position. Water level indicator LED 76 preferably outputs two levels of brightness, and more specifically, will shine in “dim” mode (via pulse width modulation) when pump dial on/off switch 74 is in an “on” position and the water level in tub 32 is at least at tub height mark 56 (FIG. 19a). Conversely, when the water level in tub 32 is lower than height mark 56 (one or none of reed switches 50, 52 being in an “on” mode), then LED 76 will shine in “bright” mode, e.g. a constant 5V output at 20 ms. Alternatively, water level indicator LED 76 will not shine at all if pump dial on/off switch 74 is in an “off” position.

Power indicator LED 78 (FIGS. 5, 20) preferably operates while CPU 70 is receiving power regardless of the position of dial switch control knobs 74, 120. The operational mode of reed switches 50, 52 directly affects the color of light output from LED 78, e.g. red or green depending on the water level and reed switch position. LED 78 is preferably “on” when pump dial switch 74 is in an “off” position. Moreover, LED lighting sub-assembly 114 is adapted to automatically enter into an “off” mode when pump 36 is shut off either due to low water level or when pump dial switch 74 is in an “off” position.

CPU 70, power supply 66, water level indicator LED 76 and associated electronics may be integrated on a printed circuit board (PCB) 67 (FIG. 14). The PCB may be housed in back fountain cover 80 (FIG. 8) which could be provided with an electrical plug 85 (FIG. 5) adapted to accommodate a male quick release connector, as generally shown in FIG. 5. The male quick release connector may be coupled at an opposite end to 12V transformer 68 (not shown).

The water fountain 30 preferably includes a face plate 132 (FIG. 19a) adapted to securely hold decorative members such as marble and wood decorative members 134, 136 (FIG. 19b). Due to different tolerances of marble and wood members 134, 136, a marble bracket 138 (FIG. 19d) and a spring plate 140 (FIG. 19c) may be utilized during manufacturing to hold marble and wood members 134, 136 tightly against the back side of face plate 132, as generally illustrated in FIG. 1. Face plate 132 may be further adapted to securely hold a logo plate, as generally shown in FIG. 19a.

The removable ramp window 106 and plenum 34 are preferably made from material(s) capable of withstanding a temperature of up to 160° F. so as to be dishwasher safe. Furthermore, any tinting used on these components should preferably be of sufficiently high quality to withstand alteration in appearance due to continuous lighting exposure from internal LED lighting subassembly 114 and/or from repeated use in automatic dishwashing units.

While the present invention has been described in detail with regards to a single preferred embodiment, it should be appreciated that various modifications and alternatives can be used without departing from the scope or spirit of the invention. In this regard it is important to note that the invention is not limited to the particular exemplary preferred embodiment described hereinabove. Rather, other applications will become apparent to those skilled in the art. It is, therefore, intended that the present application cover all such modifications and alternatives within the scope of the appended claims and their equivalents.

1. A recirculating water fountain comprising:
a reservoir for accommodating a volume of liquid;
a plenum mounted above said reservoir configured to accumulate a liquid pool;
a pump operable in a pump-on mode to pump liquid upwardly from said reservoir to form said liquid pool in said plenum;
a visibly open flow pathway sloping downwardly from beneath said plenum and configured to receive liquid from a plenum overflow for return to said reservoir;
detector means for providing a first signal when the liquid level in said reservoir is less than a predetermined first height mark and for providing a second signal when the liquid level in said reservoir is greater than a predetermined second height mark, where said second height mark is greater than said first height mark; and
controller means responsive to said first and second signals for setting a pump-off mode in response to said liquid level being less than first height mark and for preventing setting of said pump-on mode unless said liquid level is greater than said second height mark.

2. The apparatus of claim 1, wherein said reservoir includes at least one peripheral window for viewing the reservoir liquid level from outside said reservoir.

3. The apparatus of claim 1, wherein said liquid flow pathway includes a ramp portion adapted to support a substantially smooth sheet liquid flow.

4. The apparatus of claim 3 wherein said ramp portion includes spaced lateral ridges for creating ripples in said sheet liquid flow.

5. The apparatus of claim 1 wherein said flow pathway includes a substantially convex surface portion adapted to support a substantially smooth sheet liquid flow.

6. The apparatus of claim 1 wherein said flow pathway includes a substantially concave surface portion adapted to support a substantially smooth sheet liquid flow.

7. The apparatus of claim 1 wherein said detector means includes a first switch mounted proximate to said first height mark and a second switch mounted proximate to said second height mark.

8. The apparatus of claim 7 wherein said detector means further includes at least one switch actuator configured to float proximate to the liquid level in said reservoir.

9. The apparatus of claim 8 wherein said controller means is responsive to said first and second switches to define said pump-off mode when said liquid falls below said first height mark and to subsequently define said pump-on mode only after said level rises above said second height mark.

10. The apparatus of claim 8 wherein said switch actuator comprises a magnet.

11. The apparatus of claim 10 wherein at least one of said switches is responsive to a magnetic field proximate thereto.

13. An apparatus configured to pleasingly display a flowing liquid, said apparatus comprising:
a liquid reservoir;
a pump coupled to said reservoir for pumping liquid upstream to a plenum configured to form a substantially still liquid pool, said substantially still liquid pool adapted to overflow onto an upstream end of a visually open flow pathway configured to return said liquid overflow to said reservoir; and
detector means for detecting the liquid level in said reservoir; and
controller means responsive to said detector means for switching said pump off in response to the liquid level in said reservoir falling below a first height mark and for preventing resumption of pump operation unless the liquid level in said reservoir rises above a second height mark greater than first height mark.

20. A recirculating water fountain comprising:
a reservoir for accommodating a volume of liquid;
a visually open flow pathway having an upstream end and sloping downwardly to a downstream end proximate to said reservoir;
a pump operable to pump liquid upwardly from said reservoir to said upstream end;
detector means for detecting the liquid level in said reservoir; and
controller means responsive to said detector means for switching said pump off in response to the liquid level in said reservoir falling below a first height mark and for preventing resumption of pump operation unless the liquid level in said reservoir rises above a second height mark greater than first height mark.
